(19) United States
(12) Patent Application Publication
(10) Pub. No.: US 2025/0016016 A1
(43) Pub. Date: Jan. 9, 2025

(54) MBS SESSION FAILURE

(71) Applicant: Telefonaktiebolaget LM Ericsson (publ), Stockholm (SE)

(72) Inventors: Yumei SONG, Göteborg (SE); Hong ZHANG, Göteborg (SE); Jie LING, Shanghai (CN)

(73) Assignee: Telefonaktiebolaget LM Ericsson (publ), Stockholm (SE)

(21) Appl. No.: 18/709,772

(22) PCT Filed: Oct. 25, 2022
(86) PCT No.: PCT/EP2022/079816

§ 371 Date: May 13, 2024

(30) Foreign Application Priority Data
Nov. 14, 2021 (WO) PCT/CN2021/130494

(51) Int. Cl. H04L 12/18; H04W 76/11

(52) U.S. Cl. CPC H04L 12/1868; H04L 12/1886; H04L 12/189; H04W 76/11

(57) ABSTRACT

A method performed by a Radio Access Network, RAN, node, the method comprising, after a Multicast and Broadcast Services, MBS, session failure, sending (510, 601), to a first core network node, a first message indicating that the MBS session has failed, wherein the first message comprises an MBS session identifier, ID, (i.e., Temporary Mobile Group Identity, TMGI) for the failed MBS session and/or a cause code for the MBS session failure.

### TECHNICAL FIELD

This disclosure relates to techniques for reporting Multicast and Broadcast Services Session failure.

### BACKGROUND

Multicast and Broadcast Service (MBS) is a point-to-multipoint service in which data is transmitted from a single source entity to multiple recipients, either to all users in a broadcast service area, or to users in a multicast group, as defined in Third Generation Partnership Project (3GPP) Technical Standard 22.146 version 16.0.0.

The corresponding types of MBS session are: (i) Broadcast session and (ii) Multicast session. A broadcast MBS session delivers the broadcast communication service, and is characterised by the content to send, and the geographical area in which the service is distributed. A multicast MBS session delivers the multicast communication service, and is characterised by: the content to send, the list of UEs that may receive the service and, optionally, a multicast area in which the service is distributed.

The MBS service area is the area within which data of one Multicast or Broadcast MBS session may be sent. For location dependent MBS, the MBS service area is uniquely identified by the combination of Area Session ID and MBS Session ID and corresponds to the location dependent content data of the MBS Session ID.

The associated Quality of Service (QoS) Flow is a unicast QoS Flow that belongs to the associated Protocol Data Unit (PDU) Session and is used for 5G Core (5GC) Individual MBS traffic delivery method. The associated QoS Flow is mapped from a multicast QoS Flow in a multicast MBS session.

A Temporary Mobile Group Identity (TMGI) is allocated to a Multimedia Broadcast Multicast Service (MBMS) bearer service. For broadcast mode only, a Flow Identifier is also used together with the TMGI to uniquely identify an MBMS bearer.

3GPP Technical Standard 23.247 version 17.0.0 chapters 7.3.1, 7.3.2 and 7.3.3 describes the MBS Session Start, Release, and Update for Broadcast.

The MBS Session Create (with MBS service type set to broadcast service) is used by an Application Function (AF) or Application Server (AS) to indicate the impending start of the transmission of MBS data, and to provide the session attributes, so that resources for the MBS Session are set up in the Multicast/Broadcast User Plane Function (MB-UPF) and in the Next Generation Radio Access Network (NG-RAN) for 5th Generation Core (5GC) Shared MBS traffic delivery.

The MBS Session Release for broadcast follows the MBS Session Deletion (e.g. TMGI De-allocation and MBS Session Deletion) so that resource for shared MBS delivery is released.

The MBS Session Update for broadcast is used by the AF/AS to update the broadcast area or service requirements of the MBS Session which may lead to the addition of new MBS QoS Flow(s), the removal of existing MBS QoS Flow(s) and/or the update of existing MBS QoS Flow(s).

The NG-RAN may release the MBS service in the following cases:

1) NG-RAN is not dedicated to MBS broadcast and multicast, when there is other higher service received, e.g. the current MBS service is non-Guaranteed Bit Rate (GBR) service, the other higher GBR MBS service starts, or User Equipment (UE) creates PDU session for the IP Multimedia System (IMS) voice call or other high priority services, and there is not enough resource in the cell, NG-RAN may release the resource of the MBS service for the other higher priority services;

2) Other error within the NG-RAN which causes the MBS session release.

However, when the MBS session is released in NG-RAN, the AF/AS is not aware of the failure. As a consequence, important MBS information may be missed within one or more cells, which may cause a serious public safety issue.

### SUMMARY

The techniques proposed herein address these and other challenges. It is identified that, in the event of an MBS session failure, it would be beneficial for the failure to be reported to the core network. There is no statement in the current 3GPP specification Technical Standard 23.247 version 17.0.0 about the NG-RAN reporting the MBS session failure to the core network. According to the techniques disclosed herein, the NG-RAN reports the MBS session failure to the core network. It is proposed to introduce an option for an NG-RAN to report the MBS session failure to the Access and Mobility Management Function (AMF). The AMF then reports it to the Multicast/Broadcast Session Management Function (MB-SMF), and the AF/AS receives the information from MB-SMF, either directly or via the Network Exposure Function (NEF) and/or the MBS Function (MBSF).

According to a first aspect, there is provided a method performed by a Radio Access Network, RAN, node. The method comprises: after a Multicast and Broadcast Services, MBS, session failure, sending, to a first core network node, a first message indicating that the MBS session has failed.

According to a second aspect, there is provided a method performed by a first core network node. The method comprises: receiving, from a Radio Access Network, RAN, node, a first message indicating that a Multicast and Broadcast Services, MBS, session has failed.

According to a third aspect, there is provided a method performed by a second core network node. The method comprises: receiving, from a first core network node, a second message indicating that a Multicast and Broadcast Services, MBS, session has failed.

According to a fourth aspect, there is provided a Radio Access Network, RAN, node configured to perform the method according to any of the embodiments of the first aspect.

According to a fifth aspect, there is provided a first core network node configured to perform the method according to any of the embodiments of the second aspect.

According to a sixth aspect, there is provided a second core network node configured to perform the method according to any of the embodiments of the third aspect.

According to a seventh aspect, there is provided a Radio Access Network, RAN, node, that comprises a processor and a memory, said memory containing instructions executable by said processor whereby said RAN node is operative to perform the method according to any of the embodiments of the first aspect.

According to an eighth aspect, there is provided a first core network node that comprises a processor and a memory, said memory containing instructions executable by said processor whereby said first core network node is operative to perform the method according to any of the embodiments of the second aspect.

According to a ninth aspect, there is provided a second core network node that comprises a processor and a memory, said memory containing instructions executable by said processor whereby said second core network node is operative to perform the method according to any of the embodiments of the third aspect.

According to a tenth aspect, there is provided a computer program product comprising a computer readable medium having computer readable code embodied therein, the computer readable code being configured such that, on execution by a suitable computer or processor, the computer or processor is caused to perform the method according to any of the embodiments of the first, second or third aspects.

The techniques disclosed herein provide a mechanism for the AF/AS to be informed when an MBS session is released in NG-RAN. The AF/AS can adjust the policy of other services accordingly, or notify the affected UE(s) by other options. The techniques thereby prevent important MBS information from being missed within one or more cells, and prevents the occurrence of any corresponding public safety issues.

### BRIEF DESCRIPTION OF THE DRAWINGS

Some of the embodiments contemplated herein will now be described more fully with reference to the accompanying drawings, in which:

FIG. 1 illustrates a 5G System reference architecture showing service-based interfaces used within the Control Plane when MBS is used;

FIG. 2 is a radio access network node in accordance with some embodiments;

FIG. 3 is a core network node in accordance with some embodiments;

FIG. 4 is a block diagram illustrating a virtualization environment in which functions implemented by some embodiments may be virtualized;

FIG. 5 is a signalling diagram illustrating a method in accordance with some embodiments;

FIG. 6 is a flow chart illustrating a method in a Radio Access Network node in accordance with some embodiments;

FIG. 7 is a flow chart illustrating a method in a first core network node in accordance with some embodiments; and

FIG. 8 is a flow chart illustrating a method in a second core network node in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

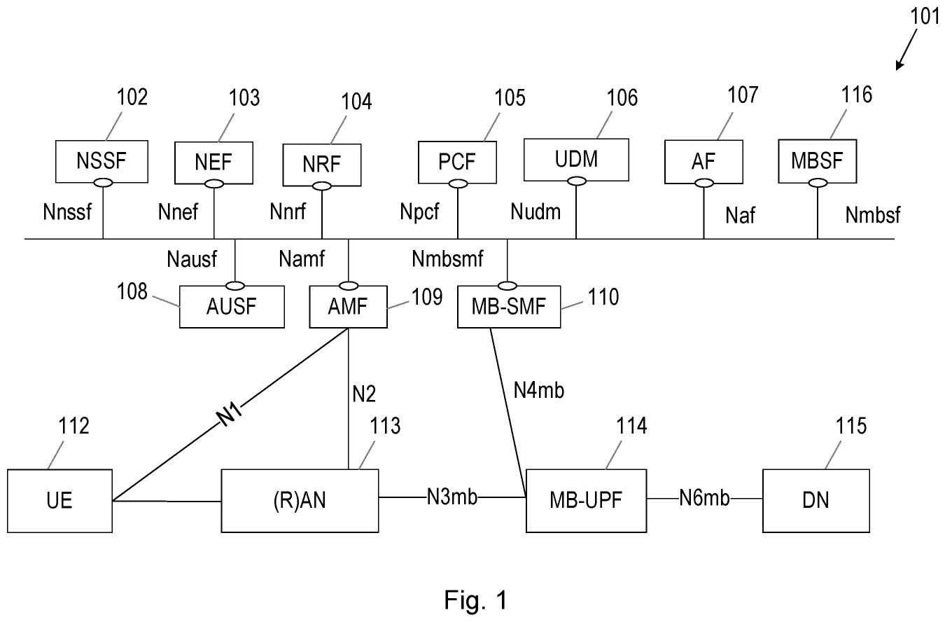

FIG. 1 illustrates a 5G system reference architecture 101 showing service-based interfaces used within the Control Plane (CP) when MBS is used. It will be appreciated that not all Network Functions (NFs) are depicted. Service-based interfaces are represented in the format Nxyz and point to point interfaces in the format Nx or Nxmb. The reference architecture 101 comprises a Network Slice Selection Function (NSSF) 102 that has a Nnssf interface, a NEF 103 that has a Nnef interface, a Network Repository Function (NRF) 104 that has a Nnrf interface, a Policy Control Function (PCF) 105 that has a Npcf interface, a Unified Data Management (UDM) 106 that has a Nudm interface, an Application Function (AF) 107 that has a Naf interface, an Authentication Server Function (AUSF) 108 that has a Nausf interface, an Access and Mobility Management Function (AMF) 109 that has a Namf interface, an MB Session Management Function (MB-SMF) 110 that has a Nmbsmf interface and a MBS Function (MBSF) 116 that has a Nmbsf interface.

The AMF 109 has an N1 interface to a user equipment (UE) 112, and an N2 interface to an access network (AN) 113 (which can be a radio AN, RAN). The MB-SMF 110 has an N4mb interface to an MB User Plane Function (MB-UPF) 114. The interface between the R(AN) 113 and the MB-UPF 114 is the N3mb interface, and the interface between the MB-UPF 114 and Data Network (DN) 115 is the N6mb interface.

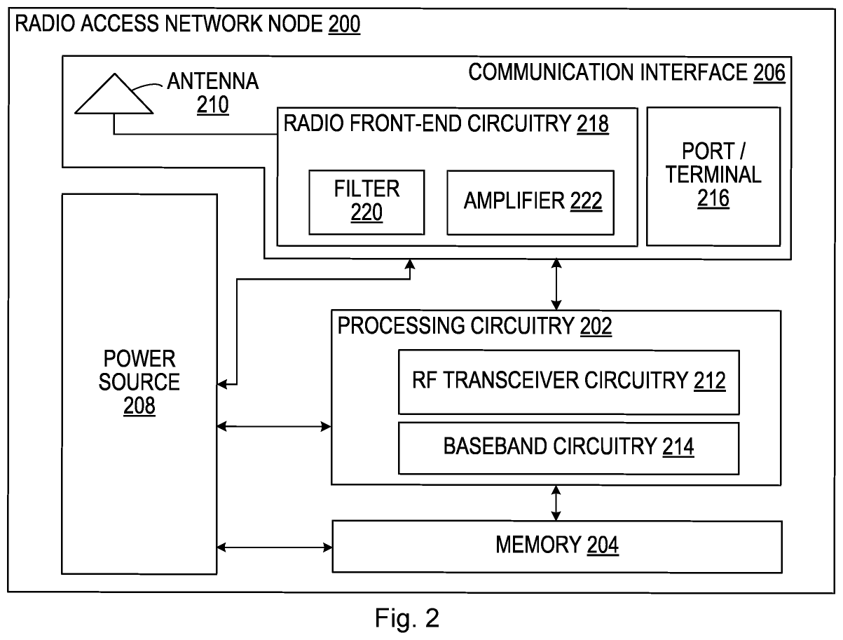

FIG. 2 shows a Radio Access Network node 200 in accordance with some embodiments. As used herein, radio access network node refers to equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)).

Base stations may be categorised based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of radio access network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The radio access network node 200 includes processing circuitry 202, a memory 204, a communication interface 206, and a power source 208, and/or any other component, or any combination thereof. The radio access network node 200 may be composed of multiple physically separate components (e.g. a NodeB component and a RNC component, or a BTS component and a BSC component, etc.), which may each have their own respective components. In certain scenarios in which the radio access network node 200 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the radio access network node 200 may be configured to support multiple radio access technologies (RATs). In such embodiments, some components may be duplicated (e.g. separate memory 204 for different RATs) and some components may be reused (e.g. a same antenna 210 may be shared by different RATs). The radio access network node 200 may also include multiple sets of the various illustrated components for different wireless technologies integrated into radio access network node 200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within radio access network node 200.

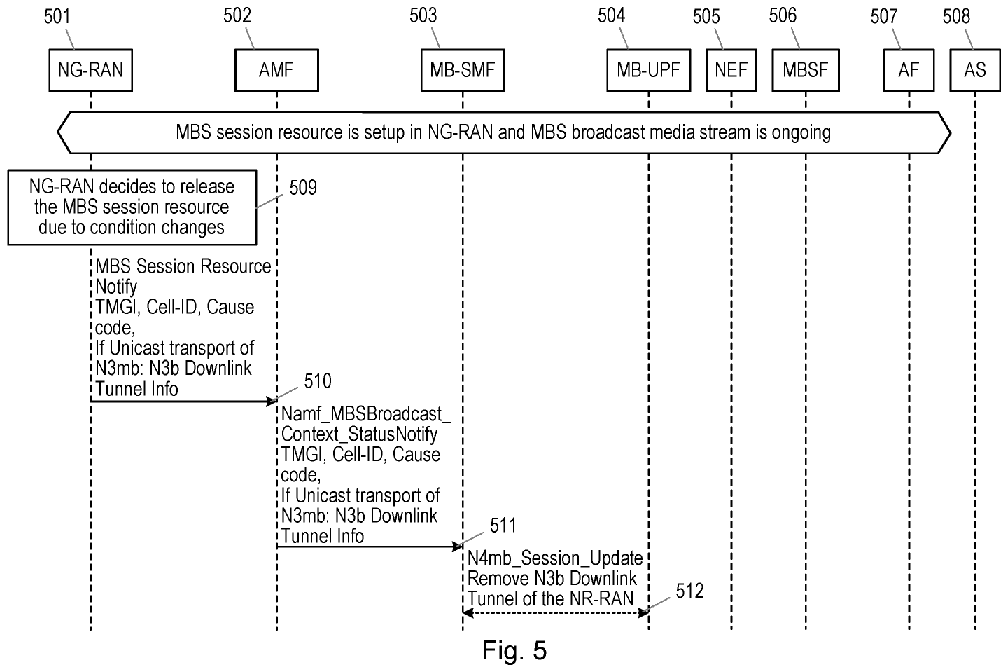

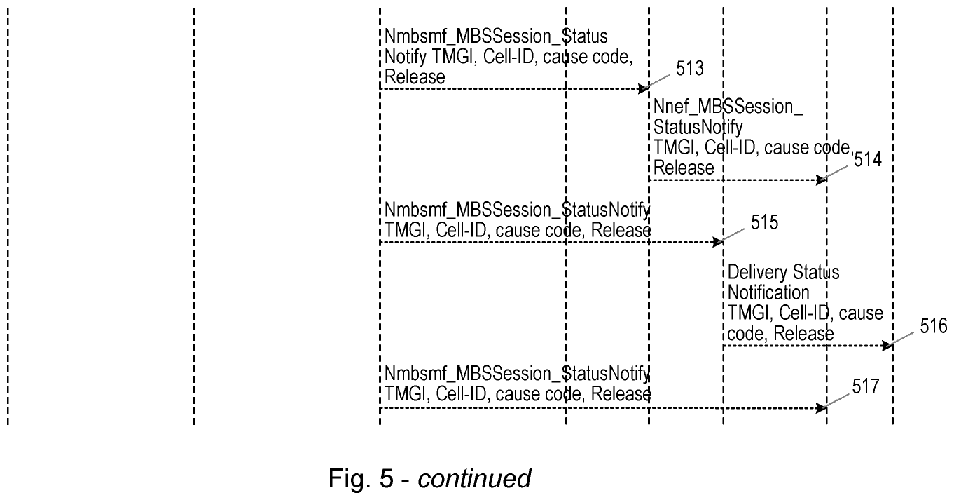

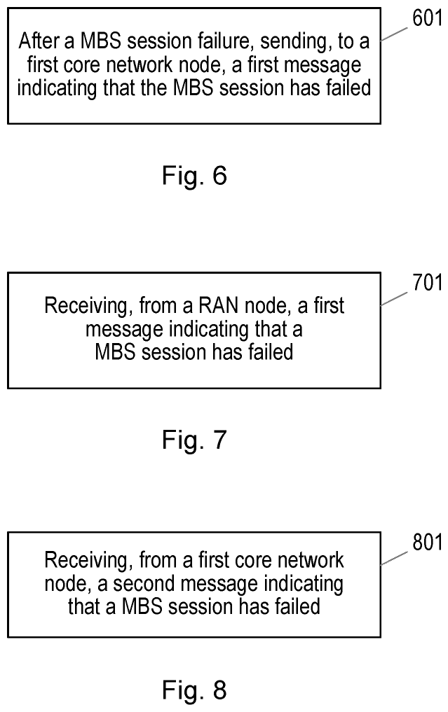

The processing circuitry 202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other radio access network node 200 components, such as the memory 204, to provide radio access network node 200 functionality. For example, the processing circuitry 202 may be configured to cause the network node to perform the methods as described with reference to FIG. 5 or 6.

In some embodiments, the processing circuitry 202 includes a system on a chip (SOC). In some embodiments, the processing circuitry 202 includes one or more of radio frequency (RF) transceiver circuitry 212 and baseband processing circuitry 214. In some embodiments, the radio frequency (RF) transceiver circuitry 212 and the baseband processing circuitry 214 may be on separate chips (or sets of chips), boards, or units, such as radio units and digital units. In alternative embodiments, part or all of RF transceiver circuitry 212 and baseband processing circuitry 214 may be on the same chip or set of chips, boards, or units.

The memory 204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 202. The memory 204 may store any suitable instructions, data, or information, including a computer program, software, an application including one or more of logic, rules, code, tables, and/or other instructions capable of being executed by the processing circuitry 202 and utilized by the radio access network node 200. The memory 204 may be used to store any calculations made by the processing circuitry 202 and/or any data received via the communication interface 206. In some embodiments, the processing circuitry 202 and memory 204 is integrated.

The communication interface 206 is used in wired or wireless communication of signalling and/or data between network nodes, the access network, the core network, and/or a UE. As illustrated, the communication interface 206 comprises port(s)/terminal(s) 216 to send and receive data, for example to and from a network over a wired connection.

The communication interface 206 also includes radio front-end circuitry 218 that may be coupled to, or in certain embodiments a part of, the antenna 210. Radio front-end circuitry 218 comprises filters 220 and amplifiers 222. The radio front-end circuitry 218 may be connected to an antenna 210 and processing circuitry 202. The radio front-end circuitry may be configured to condition signals communicated between antenna 210 and processing circuitry 202. The radio front-end circuitry 218 may receive digital data that is to be sent out to other network nodes or UEs via a wireless connection. The radio front-end circuitry 218 may convert the digital data into a radio signal having the appropriate channel and bandwidth parameters using a combination of filters 220 and/or amplifiers 222. The radio signal may then be transmitted via the antenna 210. Similarly, when receiving data, the antenna 210 may collect radio signals which are then converted into digital data by the radio front-end circuitry 218. The digital data may be passed to the processing circuitry 202. In other embodiments, the communication interface may comprise different components and/or different combinations of components.

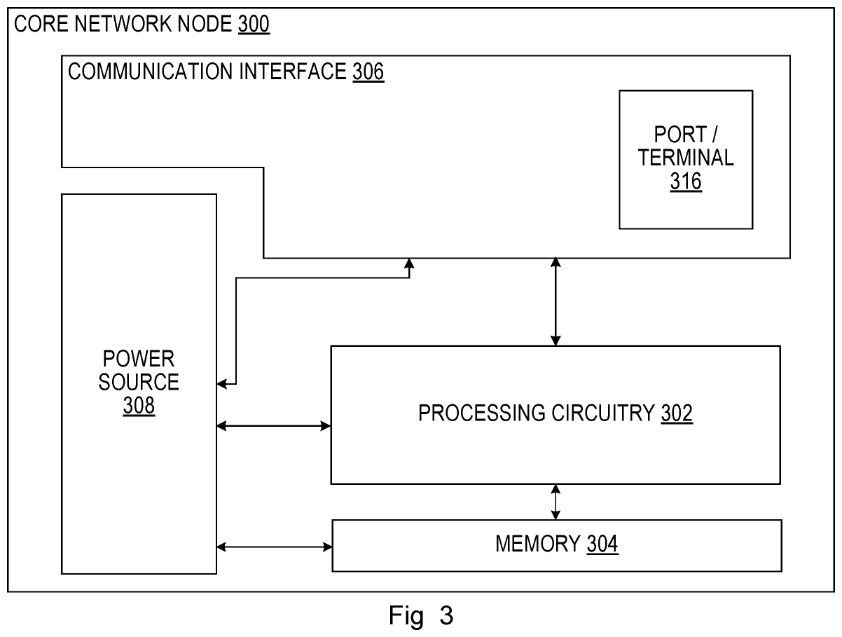

FIG. 3 shows a core network node 300 in accordance with some embodiments. As used herein, core network node refers to equipment capable, configured, arranged and/or operable to communicate directly or indirectly with a UE and/or with other network nodes or equipment, in a telecommunication network. Examples of core network nodes include, but are not limited to, nodes that include functions of one or more of a Mobile Switching Center (MSC), Mobility Management Entity (MME), Home Subscriber Server (HSS), Access and Mobility Management Function (AMF), Session Management Function (SMF), MB-SMF, Authentication Server Function (AUSF), Subscription Identifier De-concealing function (SIDF), Unified Data Management (UDM), Security Edge Protection Proxy (SEPP), Network Exposure Function (NEF), Serving Gateway (SGW), Packet Data Network Gateways (PGW), and/or a User Plane Function (UPF), MB-UPF, MBSF, Application Function (AF) and Application Server (AS).

The core network node 300 includes processing circuitry 302, a memory 304, a communication interface 306, and a power source 308, and/or any other component, or any combination thereof. The core network node 300 may be composed of multiple physically separate components, which may each have their own respective components.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other core network node 300 components, such as the memory 304, to provide core network node 300 functionality. For example, the processing circuitry 302 may be configured to cause the core network node to perform the methods as described with reference to FIGS. 5, 7 and/or 8. In some embodiments, the processing circuitry 302 includes a system on a chip (SOC).

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the core network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signalling and/or data between network nodes, the access network, the core network, and/or a UE. As illustrated, the communication interface 306 comprises port(s)/terminal(s) 316 to send and receive data, for example to and from a network over a wired connection.

The communication interface 306, and/or the processing circuitry 302 may be configured to perform any receiving operations and/or certain obtaining operations described herein as being performed by the core network node. Any information, data and/or signals may be received from an access network node (e.g. eNB or gNB), another core network node and/or any other network node or network equipment. Similarly, the communication interface 306, and/or the processing circuitry 302 may be configured to perform any transmitting operations described herein as being performed by the core network node. Any information, data and/or signals may be transmitted to an access network node, another core network node and/or any other network node or network equipment.

The power source 308 provides power to the various components of core network node 300 in a form suitable for the respective components (e.g. at a voltage and current level needed for each respective component). The power source 308 may further comprise, or be coupled to, power management circuitry to supply the components of the core network node 300 with power for performing the functionality described herein. For example, the core network node 300 may be connectable to an external power source (e.g. the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the core network node 300 may include additional components beyond those shown in FIG. 3 for providing certain aspects of the core network node's functionality, including any of the functionality described herein and/or any functionality necessary to support the subject matter described herein. For example, the core network node 300 may include user interface equipment to allow input of information into the core network node 300 and to allow output of information from the core network node 300. This may allow a user to perform diagnostic, maintenance, repair, and other administrative functions for the core network node 300.

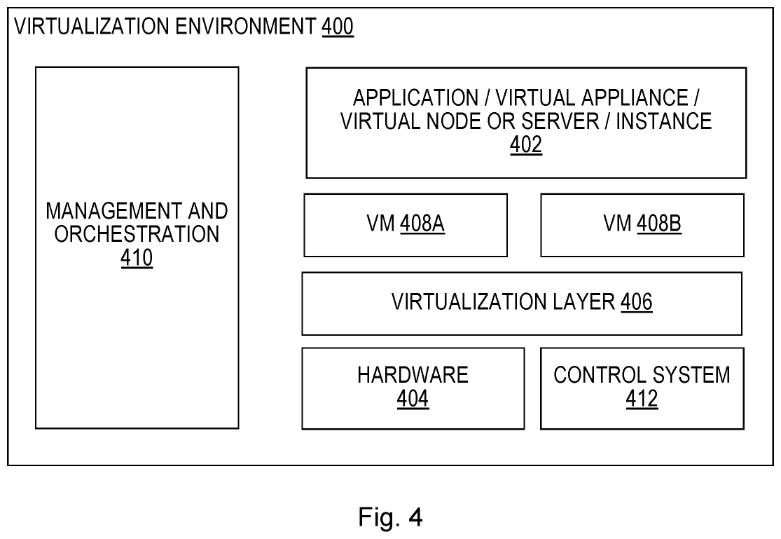

FIG. 4 is a block diagram illustrating a virtualization environment 400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) or containers (e.g. docker containers, lxc) implemented in one or more virtual environments 400 (e.g. Kubernetes (k8s) or OpenStack) hosted by one or more of hardware nodes, such as a hardware computing device that operates as an access network node, or a core network node. Further, in embodiments in which the virtual node does not require radio connectivity (e.g. a core network node), then the node may be entirely virtualized.

Applications 402 (which may alternatively be called software instances, virtual appliances, network functions, virtual nodes, virtual network functions, etc.) are run in the virtualization environment 400 to implement some of the features, functions, and/or benefits of some of the embodiments disclosed herein.

Hardware 404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 406 (also referred to as hypervisors or virtual machine monitors (VMMs)), provide VMs 408a and 408b (one or more of which may be generally referred to as VMs 408), and/or perform any of the functions, features and/or benefits described in relation with some embodiments described herein. The virtualization layer 406 may present a virtual operating platform that appears like networking hardware to the VMs 408.

The VMs 408 comprise virtual processing, virtual memory, virtual networking or interface and virtual storage, and may be run by a corresponding virtualization layer 406. Different embodiments of the instance of a virtual appliance 402 may be implemented on one or more of VMs 408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 408 may be a software implementation of a physical machine that runs programs as if they were executing on a physical, non-virtualized machine. Each of the VMs 408, and that part of hardware 404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 408 on top of the hardware 404 and corresponds to the application 402.

Hardware 404 may be implemented in a standalone network node with generic or specific components. Hardware 404 may implement some functions via virtualization. Alternatively, hardware 404 may be part of a larger cluster of hardware (e.g. such as in a data center or CPE) where many hardware nodes work together and are managed via management and orchestration 410, which, among others, oversees lifecycle management of applications 402. In some embodiments, hardware 404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 412 which may alternatively be used for communication between hardware nodes and radio units.

Although the computing devices described herein (e.g. radio access network nodes, core network nodes or network functions) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

As already discussed, the techniques disclosed herein propose to introduce an option for an NG-RAN to report a MBS session failure to the core network.

FIG. 5 is a signalling diagram illustrating a method in accordance with some embodiments. The signalling diagram shows signals/messages sent between an NG-RAN 501, an AMF 502, a MB-SMF 503, a MB-UPF 504, a NEF 505, a MBSF 506, an AF 507, and an AS 508.

In FIG. 5, an MBS Session has been successfully setup in the NG-RAN 501, and an MBS broadcast media stream is ongoing. At step 509, the NG-RAN decides to release the MBS session resource due to condition changes. For example, the NG-RAN 501 may not be dedicated to MBS broadcast and multicast, and a higher priority service (e.g. a GBR service, an IMS voice call, etc.) may also need to be provided. If there are insufficient resources available in the cell for the NG-RAN 501 to carry out both the MBS service and the higher priority service, then the NG-RAN 501 may release the resource of the MBS service for use by the other higher priority service(s). Alternatively, a condition change can be an error within the NG-RAN 501 which causes the MBS session to release.

A new message is introduced, referred to herein as MBS Session Notify or MBS Session Resource Notify for broadcast, which is used by the NG-RAN 501 to notify the AF 507 or AS 508 about the MBS session failure in one or more specific cells provided by the NG-RAN 501. When the MBS session is released in a specific cell or cells of NG-RAN 501, the NG-RAN sends the MBS Session Resource Notify message to the AMF 502. The message is sent over the N2 interface. Thus, signal 510 of FIG. 5 shows the NG-RAN 501 sending an MBS Session Resource Notify message to the AMF 502. The message includes a TMGI for the failed MBS session, one or more cell identifiers for cells in which the MBS session failure occurred, one or more MBS Quality of Service flow identifiers for the failed MBS session, and a cause code for the MBS session failure. If the RAN does not support multicast transport and therefore point to point transport is being used, the message will also include N3mb Downlink Tunnel Information.

After receiving the message from NG-RAN 501, the AMF 502 sends, in signal 511, a message to the MB-SMF 503 over the N11mb interface. This is another new message, labelled herein as Namf_MBSBroadcast_ContextNotify. This message includes TMGI, cell ID, MBS QoS flow ID, cause code. If the RAN 501 does not support multicast transport and therefore point to point transport is being used, the message will also include N3mb Downlink Tunnel Information. In other words, the AMF 502 passes the information received from the NG-RAN 501 on to the MB-SMF 503 in a newly-introduced message, Namf_MBSBroadcast_ContextNotify.

Signal 512 of FIG. 5 is an optional signal. If unicast transport is being used (e.g. because the RAN 501 does not support multicast transport), the MB-SMF 503 updates the MB-UPF 504 that the N3mb Downlink Tunnel of the NG-RAN 501 has been removed. This is an N4mb Session Update message, and is signal 512 in FIG. 5.

FIG. 5 shows three options for what the MB-SMF 503 does with the information it has received in signal 511 from the AMF 502. The option used by the MB-SMF 503 can depend on whether the destination for the MBS failure information is internal or external to the network, trusted by the network, and/or whether the destination is an AF 507 or AS 508.

In a first option, shown by signals 513 and 514, the MB-SMF 503 notifies the TMGI, cell id and QoS flow ID and the Release towards the NEF 505 (signal 513), and NEF 505 forwards the information towards the AF 507 (signal 514). The Release is an indication that the MBS session status in the reported cell/QoS flow is released due to the MBS session condition change. The Release may also include the MBS session condition change event. This first option can be used when the AF 507 is external to the core network (e.g. the AF is a third party AF) and/or when the AF is an untrusted (internal) AF. According to this first option, the AF communicates with the MB-SMF via the NEF.

In a second option, shown by signals 515 and 516, the MB-SMF 503 notifies the TMGI, cell id, QoS flow id, cause code and the Release towards the MBSF 506 in a Nmbsmf_MBSSession_StatusNotify message (signal 515), and the MBSF 506 sends a Delivery Status Indication message to legacy AS (signal 516). Thus, both the Nmbsmf_MBSSession_StatusNotify message and the Delivery Status Indication message includes the TMGI for the failed MBS session, the one or more Cell IDs for cells in which the MBS session failure occurred, a cause code for the MBS session failure, and the Release. This second option can be used when an AS is deployed (i.e. rather than an AF).

In a third option, shown by signal 517, the MB-SMF 503 notifies the TMGI, cell id and QoS flow id, cause code and the Release towards the internal AF in a Nmbsmf_MBSession_StatusNotify message. This third option can be used when the AF 507 is a trusted AF. The third option may be used when the AF 507 is internal to the core network. The internal AF may connect to the MB-SMF directly.

The messages sent/received in signals 513-517 of FIG. 5 correspond the messages in chapter 7.3.5 of 3GPP Technical Standard 23.247 version 17.0.0 (TS 23.247), where they are labelled as steps 2a-1, 2a-2, 2b-1, 2b-2 and 2c. According to the techniques disclosed herein, these messages in chapter 7.3.5 of TS 23.247 are extended to include cell id, MBS QoS flow id, and cause code, whenever MB-SMF 503 receives Namf_MBSBroadcast_ContextNotify from AMF 502 containing the cell and MBS QoS flow information. Thus, the MB-SMF 503 performs MBS Session Delivery Status Indication for Broadcast, which is specified in chapter 7.3.5 of TS 23.247, to notify the AF 507 or AS 508.

FIG. 6 is a flow chart illustrating a method performed by a Radio Access Network node in accordance with some embodiments. The RAN node may be an NG-RAN node, e.g. NG-RAN 501 shown in FIG. 5. At step 601, after a MBS session failure, the method includes sending, to a first core network node, a first message indicating that the MBS session has failed. The first core network node may be an AMF, e.g. AMF 502 shown in FIG. 5. The MBS session failure may follow MBS Session Deletion, for example due to TMGI De-allocation and MBS Session Deletion.

In some embodiments, the first message can comprise one or more of: a Temporary Mobile Group Identity, TMGI, for the failed MBS session; one or more cell identifiers for cells in which the MBS session failure occurred; one or more MBS Quality of Service flow identifiers for the failed MBS session; and a cause code for the MBS session failure. The first message may be sent on an N2 interface.

In some embodiments, the first message may comprise N3mb Downlink Tunnel Information. In some of these embodiments, point to point transport is being used. This may be because the relevant RAN does not support multicast transport.

In some embodiments, the method shown in FIG. 6 can further comprise, before sending the first message, determining that the MBS session should be released based on condition changes. The condition change may be, for example, any one or more of: the NG-RAN/cell is not dedicated to MBS broadcast and multicast; congestion occurs; or higher priority service(s) are received. If there are higher priority services, the MBS session which has lower priority will be released to give the resource to the higher priority service. As another example, the condition change could be an NG-RAN internal error (e.g. board failure) with one specific cell. In this instance, all of the sessions in that cell will be released. In these embodiments, the method may further comprise a step of releasing the MBS session.

FIG. 7 is a flow chart illustrating a method in a first core network node in accordance with some embodiments. The first core network node may be an AMF, e.g. AMF 502 shown in FIG. 5.

At step 701, the first core network node receives, from a RAN node, a first message indicating a MBS session has failed. This first message may correspond to the first message described with reference to FIG. 6. The first message may comprise one or more of: a TMGI for the failed MBS session; one or more cell identifiers for cells in which the MBS session failure occurred; one or more MBS Quality of Service flow identifiers for the failed MBS session; and a cause code for the MBS session failure. The first message may be received on an N2 interface. The RAN node may be an NG-RAN node, e.g. NG-RAN 501 shown in FIG. 5. In some embodiments, the first message may comprise N3mb Downlink Tunnel Information. In some of these embodiments, point to point transport is being used. This may be because the RAN does not support multicast transport.

In some embodiments of the method shown in FIG. 7, the method may comprise, after receiving the first message, sending, to a second core network node, a second message indicating that the MBS session has failed.

In some of these embodiments, the second message comprises one or more of: a TMGI for the failed MBS session; one or more cell identifiers for cells in which the MBS session failure occurred; one or more MBS Quality of Service flow identifiers for the failed MBS session; and a cause code for the MBS session failure. The second message may be sent over an N 11mb interface. The second core network node may be a Multicast/Broadcast Session Management Function, MB-SMF, e.g. MB-SMF 503 in FIG. 5.

FIG. 8 is a flow chart illustrating a method in a second core network node in accordance with some embodiments.

At step 801, the method comprises receiving, from a first core network node, a second message indicating an MBS session has failed. In some embodiments, the second message comprises one or more of: a TMGI for the failed MBS session; one or more cell identifiers for cells in which the MBS session failure occurred; one or more MBS Quality of Service flow identifiers for the failed MBS session; and a cause code for the MBS session failure.

The method shown in FIG. 8 may further comprise a step of, after receiving the second message, sending, to a third core network node, a third message indicating that the MBS session has failed. In some embodiments, the third message comprises one or more of: a TMGI for the failed MBS session; one or more cell identifiers for cells in which the MBS session failure occurred; one or more MBS Quality of Service flow identifiers for the failed MBS session; and a cause code for the MBS session failure.

In some embodiments, the second core network node is an MB-SMF, e.g. MB-SMF 503 in FIG. 5. In these embodiments, the first core network node may be an AMF, e.g. AMF 502 in FIG. 5. The second message may correspond to the second message described with reference to FIG. 7. In some embodiments, the second message may further comprise N3mb Downlink Tunnel Information. In some of these embodiments, point to point transport is being used. This may be because the relevant RAN does not support multicast transport.

In embodiments in which the second core network node is MB-SMF, the third core network node may be any one of: a NEF (e.g. NEF 505 in FIG. 5), a MBSF (e.g. MBSF 506 in FIG. 5) and an AF (e.g. AF 507 in FIG. 5). In some of these embodiments, the third message is a Nmbsmf_MBSSession_StatusNotify message. The third message may further comprise a Release. Here, the Release can be an indication that the MBS session status in the reported cell/QoS flow is released due to the MBS session condition change. The Release may also or instead include the MBS session condition change event.

In some embodiments, the second core network node is NEF (e.g. NEF 505 in FIG. 5) and the first core network node is MB-SMF (e.g. MB-SMF 503 in FIG. 5). In some of these embodiments, the second message is a Nmbsmf_MBSSession_StatusNotify message. The third message may be a Nnef_MBSession_StatusNotify message and the third core network node may be an AF (e.g. AF 507 in FIG. 5). In these embodiments, the second and third messages may further comprise a Release (an indication that the MBS session status in the reported cell/QoS flow is released and/or an indication of the MBS session condition change event).

In some embodiments, the second core network node is an MBSF (e.g. MBSF 506 in FIG. 5) and the first core network node is an MB-SMF, e.g. MB-SMF 503 in FIG. 5. In some of these embodiments, the second message is a Nmbsmf_MBSSession_StatusNotify message. The third message may be a Delivery Status Notification and the third core network node may be an AS (e.g. AS 508 in FIG. 5). In these embodiments, the second and third messages may further comprise a Release (an indication that the MBS session status in the reported cell/QoS flow is released and/or an indication of the MBS session condition change event).

In some embodiments, the second core network node is an AF (e.g. AF 507 in FIG. 5) and the first core network node is one of: a MB-SMF, e.g. MB-SMF 503 in FIG. 5, and a NEF (e.g. NEF 505 in FIG. 5). In these embodiments, the method of FIG. 8 may further comprise: adjusting a policy of a service based on the MBS session failure, and/or notifying a user equipment that the MBS session has failed. The second message may further comprise a Release (an indication that the MBS session status in the reported cell/QoS flow is released and/or an indication of the MBS session condition change event). In embodiments in which the first core network node is a MB-SMF, the second message may be a Nmbsmf_MBSSession_StatusNotify message. In embodiments in which the first core network node is a NEF, the second message is a Nnef_MBSession_StatusNotify message.

In some embodiments, the second core network node is an AS (e.g. AS 508 in FIG. 5) and the first core network node is an MBSF (e.g. MBSF 506 in FIG. 5). In these embodiments, the second message may be a Delivery Status Notification message, and may further comprise a Release (an indication that the MBS session status in the reported cell/QoS flow has been released and/or an indication of the MBS session condition change event).

Therefore, the techniques disclosed herein provide a method for NG-RAN to notify the AF/AS about the MBS session failure for one or more specific cells and/or QoS flows. The AF/AS can thereby adjust the policy of other services and/or notify the affected UE(s) in the affected cell(s). This is particularly advantageous if the information to be transferred over the failed MBS session is important/essential.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### Embodiment Statements

### Group A—RAN Node

1. A method performed by a Radio Access Network, RAN, node, the method comprising:
after a Multicast and Broadcast Services, MBS, session failure, sending (510, 601), to a first core network node, a first message indicating that the MBS session has failed.

2. A method as defined in statement 1, wherein the first message comprises one or more of: a Temporary Mobile Group Identity, TMGI, for the failed MBS session; one or more cell identifiers for cells in which the MBS session failure occurred; one or more MBS Quality of Service flow identifiers for the failed MBS session; a cause code for the MBS session failure; and N3mb Downlink Tunnel Information.

3. A method as defined in any of statements 1-2, wherein the first message is sent on an N2 interface.

4. A method as defined in any of statements 1-3, wherein the first core network node is an Access and Mobility Management Function, AMF.

5. A method as defined in any of statements 1-4, wherein the RAN node is a Next Generation RAN, NG-RAN, node.

6. A method as defined in any of statements 1-5, wherein the method further comprises: before sending the first message, determining (509) that the MBS session should be released based on condition changes; and releasing the MBS session.

### Group B—AMF

7. A method performed by a first core network node, the method comprising:
receiving (510, 701), from a Radio Access Network, RAN, node, a first message indicating that a Multicast and Broadcast Services, MBS, session has failed.

8. A method as defined by statement 7, wherein the method further comprises:
after receiving the first message, sending (511), to a second core network node, a second message indicating that the MBS session has failed.

9. A method as defined in statement 8, wherein the second message comprises one or more of: a Temporary Mobile Group Identity, TMGI, for the failed MBS session; one or more cell identifiers for cells in which the MBS session failure occurred; one or more MBS Quality of Service flow identifiers for the failed MBS session; a cause code for the MBS session failure; and N3mb Downlink Tunnel Information.

10. A method as defined in any of statements 8-9, wherein the second message is sent over an N11mb interface.

11. A method as defined in any of statements 8-10, wherein the second core network node is a Multicast/Broadcast Session Management Function, MB-SMF.

12. A method as defined in any of statements 7-11, wherein the first message comprises one or more of: a Temporary Mobile Group Identity, TMGI, for the failed MBS session; one or more cell identifiers for cells in which the MBS session failure occurred; one or more MBS Quality of Service flow identifiers for the failed MBS session; a cause code for the MBS session failure; and N3mb Downlink Tunnel Information.

13. A method as defined in any of statements 7-12, wherein the first message is received on an N2 interface.

14. A method as defined in any of statements 7-13, wherein the first core network node is an Access and Mobility Management Function, AMF.

15. A method as defined in any of statements 7-14, wherein the RAN node is a Next Generation RAN, NG-RAN, node.

### Group C—Other Core Network Nodes

16. A method performed by a second core network node, the method comprising:
receiving (801, 511, 513, 514, 515, 516, 517), from a first core network node, a second message indicating that a Multicast and Broadcast Services, MBS, session has failed.

17. A method as defined in statement 16, wherein the second message comprises one or more of: a Temporary Mobile Group Identity, TMGI, for the failed MBS session; one or more cell identifiers for cells in which the MBS session failure occurred; one or more MBS Quality of Service flow identifiers for the failed MBS session; a cause code for the MBS session failure; N3mb Downlink Tunnel Information; and an indication that the MBS session has been released.

18. A method as defined in statement 16 or 17, wherein the first core network node is an Access and Mobility Management Function, AMF, and the second core network node is a Multicast/Broadcast Session Management Function, MB-SMF.

19. A method as defined in statement 16 or 17, wherein the first core network node is a Multicast/Broadcast Session Management Function, MB-SMF and the second core network node is a Network Exposure Function, NEF.

20. A method as defined in statement 16 or 17, wherein the first core network node is a Multicast/Broadcast Session Management Function, MB-SMF and the second core network node is a Multicast/Broadcast Service Function, MBSF.

21. A method as defined in any of statements 16-20, wherein the method further comprises:
after receiving the second message, sending, to a third core network node, a third message indicating that the MBS session has failed.

22. A method as defined in statement 21, wherein the third message comprises one or more of: a Temporary Mobile Group Identity, TMGI, for the failed MBS session; one or more cell identifiers for cells in which the MBS session failure occurred; one or more MBS Quality of Service flow identifiers for the failed MBS session; a cause code for the MBS session failure; and an indication that the MBS session has been released.

23. A method as defined in statement 21 or 22, wherein the third message is one of a MBSSession_StatusNotify message and a Delivery Status Notification message.

24. A method as defined in any of statements 21-23, wherein the third core network node is one of: a Network Exposure Function, NEF, a Multicast/Broadcast Service Function, MBSF, an Application Function, AF, and an Application Server, AS.

25. A method as defined in statement 16 or 17, wherein the first core network node is a Multicast/Broadcast Session Management Function, MB-SMF, or a Network Exposure Function, NEF, and the second core network node is an Application Function, AF.

26. A method as defined in statement 25, the method further comprising:
adjusting a policy of a service based on the MBS session failure.

27. A method as defined in statement 25 or 26, the method further comprising:
notifying a user equipment that the MBS session has failed.

28. A method as defined in statement 16 or 17, wherein the first core network node is a Multicast/Broadcast Service Function, MBSF, and the second core network node is an Application Server, AS.

29. A method as defined in statement 28, wherein the second message is a Delivery Status Notification message.

### Group D

30. A Radio Access Network, RAN, node (113, 200, 501) configured to perform the method according to any of the embodiments in Group A.

31. A first core network node (109, 300, 502) configured to perform the method according to any of the embodiments in Group B.

32. A second core network node (103, 107, 110, 116, 300, 503, 505, 506, 507, 508) configured to perform the method according to any of the embodiments in Group C.

33. A Radio Access Network, RAN, node that comprises a processor and a memory, said memory containing instructions executable by said processor whereby said RAN node is operative to perform the method according to any of the embodiments in Group A.

34. A first core network node that comprises a processor and a memory, said memory containing instructions executable by said processor whereby said first core network node is operative to perform the method according to any of the embodiments in Group B.

35. A second core network node that comprises a processor and a memory, said memory containing instructions executable by said processor whereby said second core network node is operative to perform the method according to any of the embodiments in Group C.

36. A computer program product comprising a computer readable medium having computer readable code embodied therein, the computer readable code being configured such that, on execution by a suitable computer or processor, the computer or processor is caused to perform the method according to any of the embodiments in Group A, Group B or Group C.

1. A method performed by a Radio Access Network (RAN) node, the method comprising:
after a Multicast and Broadcast Services (MBS) session failure, sending to a first core network node, a first message indicating that the MBS session has failed, wherein the first message comprises an MBS session identifier (ID) for the failed MBS session and/or a cause code for the MBS session failure.

2. The method of claim 1, wherein the first message comprises one or more of:
one or more cell identifiers for cells in which the MBS session failure occurred; one or more MBS Quality of Service flow identifiers for the failed MBS session; and N3mb Downlink Tunnel Information.

3. The method of claim 1, wherein
the first message is sent on an N2 interface,
the first core network node is an Access and Mobility Management Function (AMF), and/or
the RAN node is a Next Generation RAN (NG-RAN).

4. (canceled)

5. (canceled)

6. The method of claim 1, wherein the method further comprises:
before sending the first message, determining that the MBS session should be released based on condition changes; and
releasing the MBS session.

7. A method performed by a first core network node, the method comprising:
receiving, from a Radio Access Network (RAN) node, a first message indicating that a Multicast and Broadcast Services (MBS) session has failed; wherein the first message comprises an MBS session identifier (ID) for the failed MBS session and/or a cause code for the MBS session failure.

8. The method of claim 7, wherein the method further comprises:
after receiving the first message, sending, to a second core network node, a second message indicating that the MBS session has failed; wherein
the second message comprises an MBS session identifier (ID) for the failed MBS session and/or a cause code for the MBS session failure, and/or
the second message comprises one or more of: one or more cell identifiers for cells in which the MBS session failure occurred; one or more MBS Quality of Service flow identifiers for the failed MBS session; and N3mb Downlink Tunnel Information.

9. (canceled)

10. The method of claim 8, wherein
the second message is sent over an N11mb interface, and/or
the second core network node is a Multicast/Broadcast Session Management Function (MB-SMF).

11. (canceled)

12. The method of claim 7, wherein the first message comprises one or more of: one or more cell identifiers for cells in which the MBS session failure occurred; one or more MBS Quality of Service flow identifiers for the failed MBS session; and N3mb Downlink Tunnel Information.

13. The method of claim 7, wherein
the first message is received on an N2 interface,
the first core network node is an Access and Mobility Management Function (AMF), and/or
the RAN node is a Next Generation RAN (NG-RAN).

14. (canceled)

15. (canceled)

16. A method performed by a second core network node, the method comprising:
receiving, from a first core network node, a second message indicating that a Multicast and Broadcast Services (MBS) session has failed; wherein the second message comprises an MBS session identifier (ID) for the failed MBS session and/or a cause code for the MBS session failure.

17. The method of claim 16, wherein the second message comprises one or more of: one or more cell identifiers for cells in which the MBS session failure occurred; one or more MBS Quality of Service flow identifiers for the failed MBS session; N3mb Downlink Tunnel Information; and an indication that the MBS session has been released.

18. The method of claim 16, wherein
the first core network node is an Access and Mobility Management Function (AMF) and the second core network node is a Multicast/Broadcast Session Management Function (MB-SMF),
the first core network node is a Multicast/Broadcast Session Management Function (MB-SMF) and the second core network node is a Network Exposure Function (NEF), or
the first core network node is a Multicast/Broadcast Session Management Function (MB-SMF) and the second core network node is a Multicast/Broadcast Service Function (MBSF).

19. (canceled)

20. (canceled)

21. The method of claim 16, wherein the method further comprises:
after receiving the second message, sending, to a third core network node, a third message indicating that the MBS session has failed, wherein
the third message is one of a MBSSession_StatusNotify message and a Delivery Status Notification message, and/or
the third core network node is one of: a Network Exposure Function (NEF), NEF, a Multicast/Broadcast Service Function, MBSF, an Application Function (AF), AF, and an Application Server (AS).

22. The method of claim 21, wherein the third message comprises one or more of: a MBS session identifier (ID) for the failed MBS session; one or more cell identifiers for cells in which the MBS session failure occurred; one or more MBS Quality of Service flow identifiers for the failed MBS session; a cause code for the MBS session failure; and an indication that the MBS session has been released.

23. (canceled)

24. (canceled)

25. The method of claim 16, wherein
the first core network node is a Multicast/Broadcast Session Management Function (MB-SMF) or a Network Exposure Function (NEF) and the second core network node is an Application Function (AF), or
the first core network node is a Multicast/Broadcast Service Function (MBSF), MBSF, and the second core network node is an Application Server (AS).

26. The method of claim 25, the method further comprising:
adjusting a policy of a service based on the MBS session failure, and/or
notifying a user equipment that the MBS session has failed.

27. (canceled)

28. (canceled)

29. The method of claim 21, wherein the second message is a Delivery Status Notification message.

30. (canceled)

31. (canceled)

32. (canceled)

33. A Radio Access Network (RAN) node that comprises a processor and a memory, said memory containing instructions executable by said processor whereby said RAN node is operative to perform the method of claim 1.

34. A first core network node that comprises a processor and a memory, said memory containing instructions executable by said processor whereby said first core network node is operative to perform the method of claim 7.

35. A second core network node that comprises a processor and a memory, said memory containing instructions executable by said processor whereby said second core network node is operative to perform the method of claim 16.

36. (canceled)
